(19) United States
(12) Patent Application Publication
(10) Pub. No.: US 2015/0095314 A1
(43) Pub. Date: Apr. 2, 2015

(54) DOCUMENT SEARCH APPARATUS AND METHOD

(71) Applicant: KABUSHIKI KAISHA TOSHIBA, Tokyo (JP)

(72) Inventors: Masayuki Okamoto, Kawasaki Kanagawa (JP); Kosei Fume, Kawasaki Kanagawa (JP)

(21) Appl. No.: 14/500,149

(22) Filed: Sep. 29, 2014

(30) Foreign Application Priority Data
Sep. 30, 2013 (JP) 2013-205831

(51) Int. Cl. G06F 17/24; G06F 17/30

(52) U.S. Cl. CPC G06F 17/241; G06F 17/30112
USPC 707/722

(57) ABSTRACT

According to one embodiment, a related document search apparatus includes a first acquisition unit, a storage, a search unit, a second acquisition unit, a determination unit and a display. The first acquisition unit acquires a document and first annotation added to the document. The search unit searches for document(s) related to content of a search document from the storage, to acquire searched document(s) as related document(s). The determination unit determines whether the second annotation includes a character. The display displays the search document and the second annotation if the second annotation information includes a character, and to display the search document, the second annotation, and an area of the related document to which the second annotation is added if the second annotation includes no character.

### CROSS-REFERENCE TO RELATED APPLICATIONS

This application is based upon and claims the benefit of priority from Japanese Patent Application No. 2013-205831, filed Sep. 30, 2013, the entire contents of which are incorporated herein by reference.

### FIELD

Embodiments described herein relate generally to a related document search apparatus and method.

### BACKGROUND

It has been broadly practiced to input characters to an electronic device by handwriting using a touch pen. In addition to personal digital assistants (PDAs), the popularization of smart phones, tablet terminals, and portable game devices have increased the number of devices having a pen input function.

These devices may have a function of adding an annotation handwritten by a user such as scrapping (clipping, enclosing), underlining, marking (adding a circle or a star mark), and bookmarking a Web page or an electronic book. Such a function allows the user to add an annotation easily and instinctively by using a browsing means or an input means that is very similar to a paper and pen or the like that the user is accustomed to.

For the electronic devices having such an annotation function, a technique to search for a document with an annotation for later use has been used.

### BRIEF DESCRIPTION OF THE DRAWINGS

FIG. 1 is an exemplary block diagram illustrating a related document search apparatus.

FIG. 2 illustrates an example of information stored in a document storage.

FIG. 3 illustrates an example of annotation information stored in an annotation information storage.

FIG. 4 illustrates an example of correspondence information stored in a correspondence information storage.

FIG. 5 is an exemplary flowchart illustrating the operation of the related document search apparatus.

FIG. 6 illustrates an example of a first usage of the related document search apparatus.

FIG. 7 illustrates an example of a second usage of the related document search apparatus.

### DETAILED DESCRIPTION

For smart phones or tablet terminals having a screen smaller than TVs or desktop PCs, or single-window terminals on which only one application window is displayed at a time, when documents similar to or related to a document being browsed are searched, only a small number of search results can be superimposed on the document.

In general, according to one embodiment, a related document search apparatus includes a first acquisition unit, a storage, a search unit, a second acquisition unit, a determination unit and a display. The first acquisition unit is configured to acquire a document and first annotation information added to the document. The storage is configured to store the document, the first annotation information, and correspondence information between the document and the first annotation information. The search unit is configured to search for at least one document related to content of a search document from the storage, to acquire at least one searched document as at least one related document, the search document being a document for a search query. The second acquisition unit is configured to acquire second annotation information which is added to the at least one related document, based on the correspondence information. The determination unit is configured to determine whether or not the second annotation information includes a character. The display is configured to display the search document and the second annotation information if the second annotation information includes a character, and to display the search document, the second annotation information, and an area of the related document to which the second annotation information is added if the second annotation information includes no character.

In the following, the related document search apparatus and method according to the present embodiment will be described in detail with reference to the drawings. In the embodiment described below, elements specified by the same reference number carry out the same operation, and a duplicate description of such elements will be omitted.

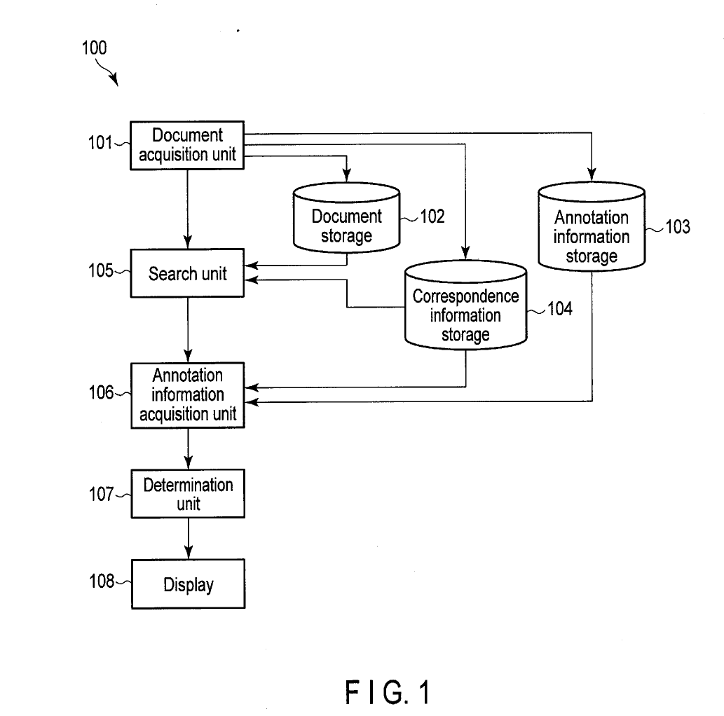

The related document search apparatus according to the embodiment with reference to the block diagram shown in FIG. 1 is described as follows.

The related document search apparatus 100 includes a document acquisition unit 101, a document storage 102, an annotation information storage 103, a correspondence information storage 104, a search unit 105, an annotation information acquisition unit 106, a determination unit 107, and a display 108. It is assumed that the related document search apparatus 100 of the present embodiment is used for a terminal which can input an annotation (for example, a personal computer, a smart phone, a tablet terminal, an electronic document reader, a video game terminal, etc.), but is not limited thereto. For convenience of explanation, the related document search apparatus 100 divides a storage function into the document storage 102, the annotation information storage 103, and the correspondence information storage 104, but the function may be accomplished in a single storage.

The document acquisition unit 101 acquires a document and annotation information. The document to be acquired by the document acquisition unit 101 may be a document created by a user or a document browsed by a user. The acquired document will be a search query when searching for a related document. The acquired document is referred to as a search document or a query document. The annotation information indicates information of an annotation including a comment/note or a mark superimposed on the document by the user. An annotation indicates a user's intention, for example, to bookmark an image, a document of an electronic book or magazine, or a Web page by enclosing or underlining an area of interest, or by adding a user's handwritten note.

The correspondence information between the annotation information and the area of the document (if there are multiple pages in the document, the page number and the area) in which the annotation information has been added, can be determined when the annotation information is added in the document acquisition unit 101.

The document acquisition unit 101 may collect documents to which an annotation is initially added. In this case, a separation unit (not shown in the drawings) may extract an annotation and separate it from a document.

The document storage 102 receives a document from the document acquisition unit 101 and stores the document.

The annotation information storage 103 receives annotation information from the document acquisition unit 101 and stores it.

The correspondence information storage 104 receives information indicating the correspondence information between the document and the annotation information from the document acquisition unit 101 and stores it. If a document consists of multiple pages, annotation information is associated with an area of a corresponding page in which the annotation information is added.

The search unit 105 receives a search document from the document acquisition unit 101, searches for a document related to the content of the search document based on the documents stored in the document storage 102 and the correspondence information stored in the correspondence information storage 104, and acquires a document related to the search document (referred to as a related document).

The annotation information acquisition unit 106 receives the related document from the search unit 105, and acquires annotation information superimposed on the related document, based on the correspondence information stored in the correspondence information storage 104.

The determination unit 107 receives the related document and annotation information of the related document from the annotation information acquisition unit 106, and determines whether or not the annotation information includes a character.

The display 108 receives the related document and the annotation information of the related document from the determination unit 107, and switches display modes in accordance with the type of annotation information. The types of annotation information include a comment/note and a mark such as an underline, a circle, and a symbol. If the annotation information includes a character, the annotation information is displayed along with the search document. If the annotation information does not include a character, the annotation information and an area of the related document in which the annotation information is added are displayed along with the search document. For example, if an underline is added to the document, a string of characters to which the underline is added may be displayed, and if a string of characters is encircled, the encircled portion may be displayed. An area to be displayed may be set to be broader than the area exactly designated by an underline or an enclosure to ensure that the required text designated by the user is included.

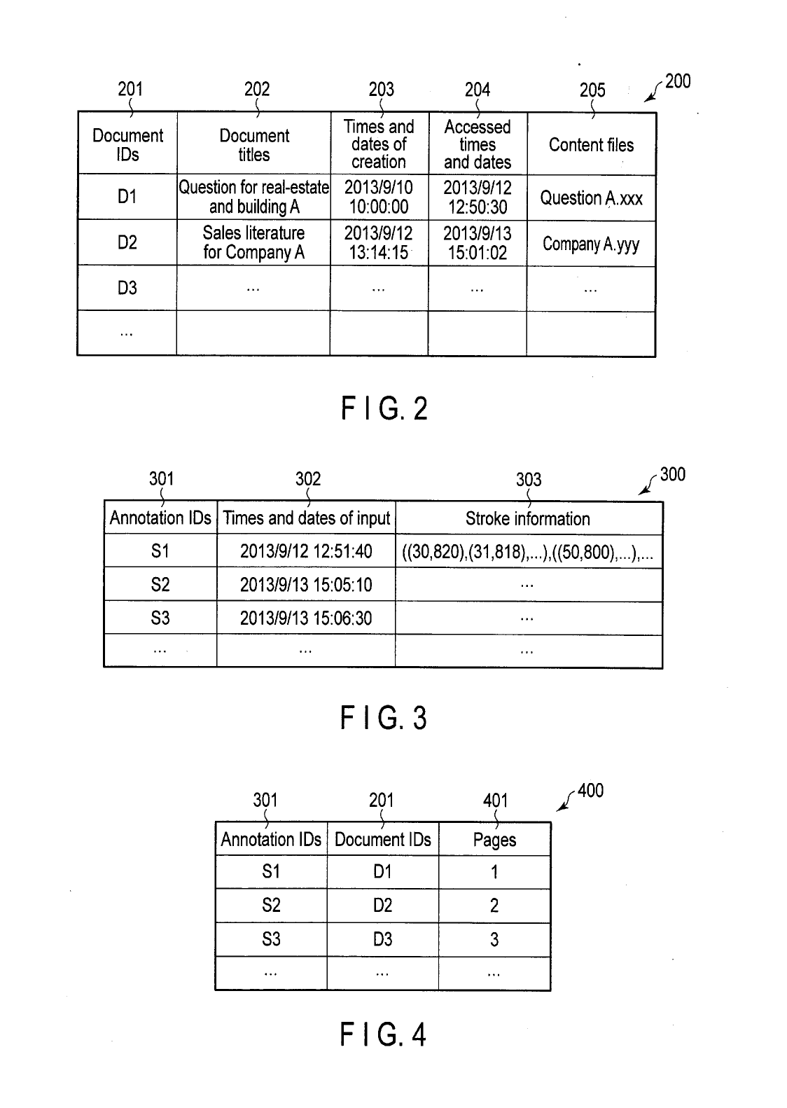

Next, an example of information on documents stored in the document storage 102 will be explained with reference to FIG. 2.

Table 200 in FIG. 2 stores document IDs 201, document titles 202, times and dates of creation 203, accessed times and dates 204 and content files 205, which are associated with each other.

The document ID 201 is an identifier (ID) unique to a document. The document title 202 is a title of a document. The time and date of creation 203 is a time and date when a document is created. The accessed time and date 204 is a time and date when a user browsed a document. The content file 205 is a title of a document data file.

For example, for the document ID 201 “D1,” the document title 202 “Questions for real-estate and building A,” the time and date of creation 203 “2013/9/10, 10:00:00,” the accessed time and date 204 “2013/9/12, 12:50:30,” and the content file 205 “Question A.xxx” are associated with each other. For the content file 205, “.xxx” refers to an extension.

An example of annotation information stored in the annotation information storage 103 will be explained with reference to FIG. 3.

Table 300 in FIG. 3 stores annotation IDs 301, times and dates of input 302, and stroke information 303 that are associated with each other. The annotation ID 301 is an identifier (ID) unique to each stroke forming an annotation drawn by a user. The time and date of input 302 is a time and date when a stroke is entered. The stroke information 303 indicates coordinates of a stroke for each sampling point. A stroke is sampled at regular intervals. The coordinates indicate correspondence between a stroke and an area of a document in which the stroke is entered, and may be coordinates on a display screen, or on a page of a document.

For example, for the annotation ID 301 “S1,” the time and date of input 302 “Sep. 12, 2013, 12:51:40” and the stroke information 303 “((30, 820), (31, 818), . . . ), ((50, 800), . . . )” are associated with each other.

An example of correspondence information stored in the correspondence information storage 104 will be explained with reference to FIG. 4.

Table 400 in FIG. 4 stores annotation IDs 301, document IDs 201, and pages 401 that are associated with each other.

The page 401 is a page number of a document on which annotation information is added. For example, for the annotation ID 301 “S1,” the document ID 201 “D1” and the page 401 “1” are associated with each other.

In this embodiment, minimum information indicating correspondence between a document and an annotation is stored; however, layout information, color information, a user ID for a user who has entered a document or an annotation, information for deletion of a document, or an annotation may be additionally stored. In addition to the time and date for creation, the accessed time and date, the entry time and date, and the times and dates for editing or saving the document may be stored for each document or annotation.

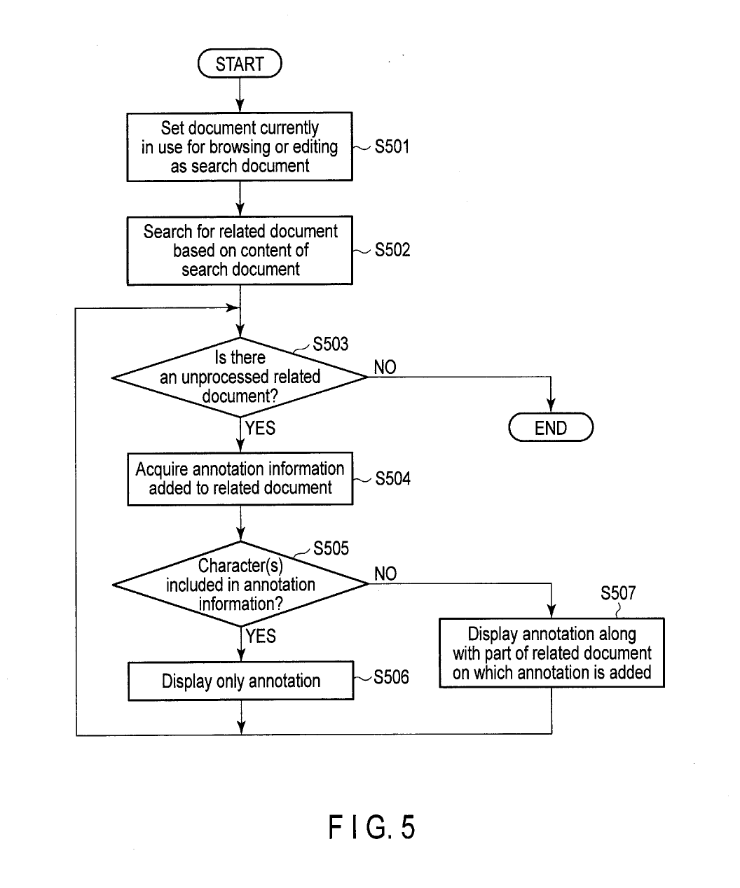

Next, the operation of the related document search apparatus 100 with reference to the flowchart shown in FIG. 5 will be explained.

In step S501, the document acquisition unit 101 sets a document currently in use for browsing or editing by a user as a search document. The document acquisition unit 101 may set a predetermined area of a document, instead of the entire document, as a search document.

In step S502, the search unit 105 searches for a related document that is related to the search document. The related document may be determined based on commonality of content (words or phrases). For example, if the probability that the same word appears between a document and the search document is not less than a threshold, the document is determined as a related document. To divide words or sentences for determining commonality, the conventional technology of morphological analysis or processing for different types of characters (numbers, letters of the alphabet, spaces, symbols, Kanji/Chinese characters, hiragana and katakana) can be used.

In addition to the commonality of content, a conceptual hierarchy of words, or similarity in the accessed time and date, the time and date for creation, or time of editing the documents may be used. The accessed time and date 204 of a document or the time and date of input 302 of annotation information may be used for determining a similarity in time and date. For example, documents such as daily reports or annual reports in a business setting that may be created at a certain time and date have commonality. For such documents, it is possible to search for related documents based on the similarity in time and date for creation.

In step S503, the search unit 105 determines if there is a related document that has not been processed. If an unprocessed related document is detected, step S504 is executed. If not, the operation of the related document search apparatus is terminated.

In step S504, the annotation information acquisition unit 106 acquires annotation information added to the related document. The annotation information acquisition unit 106 may perform character recognition processing of the annotation information and apply the results of character recognition to the correspondence stored in the correspondence information storage 104. By this process, the search range for correspondence information of related documents can be expanded.

In step S505, the determination unit 107 determines the type of annotation information and determines whether or not the annotation information includes a character. If a character is included in the annotation information, step S506 is executed. If not, step S507 is executed. It may be determined whether or not a character is included in annotation information by performing conventional handwriting character recognition processing of the entire annotation information, calculating the number of characters included in the annotation information, and determining whether or not the calculated number of characters is not less than a threshold. The threshold may be an integer not less than one. The method for determining whether or not the annotation information includes a character is not limited to the above, but may be any method for detecting a character.

The determination in step S505 may be performed not only on the entire annotation, but also on part of an annotation, and the annotation may be divided into areas that include a character and areas that do not include a character. To partially perform the determination, a method for dividing an area into rectangular sections may be used. If character recognition is performed on several neighboring strokes, a distribution of areas of rectangles circumscribing each stroke or diameters of ellipses circumscribing each stroke is computed, and character recognition is performed for each cluster of strokes. The areas of circumscribing rectangles or diameters of circumscribing ellipses are different between the cases where a character is added, and where an underline or a circle enclosing certain text is added. Accordingly, the strokes of a character and a stroke of an underline or a circular enclosure can be separated. The character recognition processing can therefore be separately performed for characters and underlines or circular enclosures.

In step S506, if a character is included in annotation information, it is assumed that the annotation information itself represents text, and thus the display 108 displays only the annotation. Then, the process returns to step S503, and the same processing is repeated.

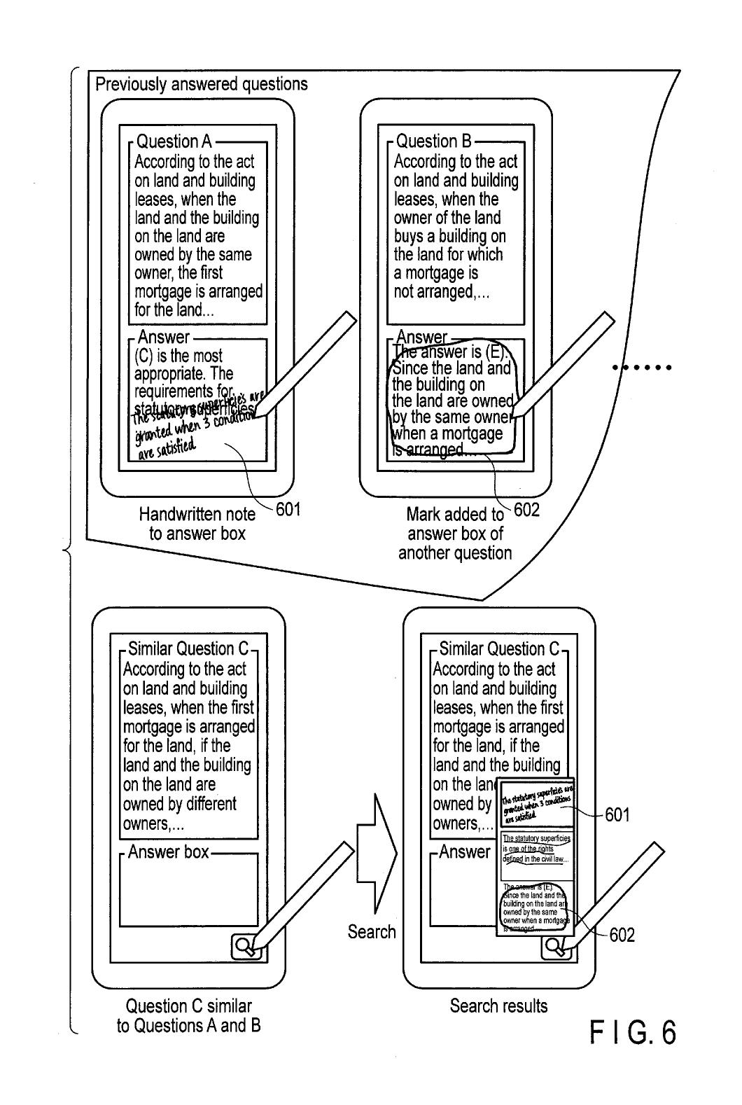

In step S507, if a character is not included in annotation information, it is assumed that the annotation information does not represent text. Accordingly, it is necessary to acquire text of the related document within an underlined or encircled area. In this case, the display 108 displays the annotation along with the part of the related document on which the annotation is added. Then, the process returns to step S503, and the same processing is repeated. The operation of the related document search apparatus 100 is completed by the above process. Next, the first example of using the related document search apparatus 100 with reference to FIG. 6 will be explained.

FIG. 6 illustrates the case where a user refers to a note that was previously written on a digital workbook when the user answers a similar question. The note was made to an answer box for a question that the user previously answered. For Question A, a note is added to the answer box, which is indicated by a note 601. For Question B, the answer is encircled, which is indicated by a mark 602. For example, it is assumed that the user who is trying to answer a Similar Question C related to Question A and Question B wishes to refer to answers of the related questions. The user may encounter a problem that there is not enough space on a screen to display Question A or B along with Similar Question C. Through the search operation of the related document search apparatus 100 of the present embodiment, it is detected that annotation information of the note 601 added to Question A includes characters, and only the note 601 extracted from Question A is displayed. On the other hand, it is detected that annotation information of mark 602 added to Question B does not include a character, and the mark 602 and an area of Question B enclosed with the mark 602 extracted from Question B are displayed. For the note 601 that includes characters, only the annotation information is displayed without displaying a part of Question A to which the note 601 is superimposed. Accordingly, the user can easily read the note 601 because the added characters (annotation) are not superimposed on the original text. For the mark 602, which does not include a character, a part of Question B enclosed with the mark 602 is displayed along with the mark 602. Accordingly, the user can effectively refer to the mark 602. By using annotation information, only an annotation or the area on which an annotation is added can be displayed, thereby reducing the required display area. If a string of characters is superimposed on text, only the superimposed characters are displayed, thereby increasing readability.

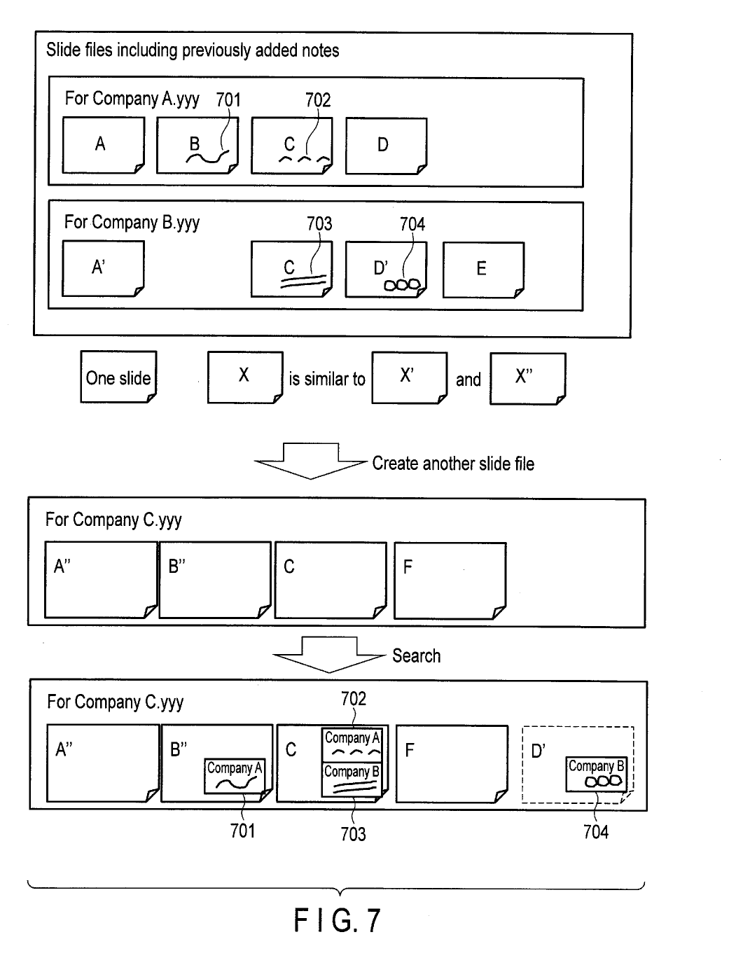

Next, the second example of using the related document search apparatus 100 with reference to FIG. 7 will be explained.

FIG. 7 illustrates the case where a user creates a new slide presentation (or ‘slide file’) for a certain company by using slide presentation files that have been previously created for different companies and are related to the new slide presentation. A slide file for company A (for company A.yyy) and a slide file for company B (for company b.yyy) were created beforehand, and handwritten notes were added to part of the files. In FIG. 7, “.yyy” refers to an extension. For the file for company A, a note 701 and a note 702 were added, and for the file for company B, a note 703 and a note 704 were added. Each slide is represented by A, B, C . . . , and a letter with a prime, such as A′ and A″, represents a slide similar to the slide with the letter without a prime (in this case, A′ and A″ are similar to A). For example, only “company A” in slide A is changed to “company B” in slide A′.

When the user is creating a slide file for company C (for company C.yyy), if a search operation is performed for the previously created slides, similar slides are detected, and the detected slides are displayed in the state where notes 701-703 are superimposed.

When searching for files related to slide file C, both of the files for company A and company B to which different notes were added, are displayed. If the notes added to the searched files are the same, only one note is displayed to avoid duplication. Only different notes may be displayed. The file for company B includes a slide D′ on which a note 704 was added. However, the slide D′ or a slide similar to the slide D′ is not included in the file for company C. In this case, it may be possible to add a slide with the note 704 to remind the user of the note previously added to the slide D′.

According to the related document search apparatus described above, annotation information indicating an annotation entered into a document is stored, and a related document and an annotation are displayed in accordance with the type of the annotation information as a result of a document search. With such an apparatus, it is possible to compare search results of related documents or to find handwritten notes added to the related documents even on a terminal having a limited display area, such as a tablet terminal. In addition, annotations that may be concealed in stored documents can be easily utilized when they are needed. Furthermore, using the search operation of the related document search apparatus can avoid the necessity of opening similar documents that were previously created every time the user creates a new document, and can avoid missing/overlooking comments that were added before.

The related document search apparatus of the above embodiment is assumed to be implemented in a portable hardware apparatus; however, part of the functions of the apparatus can be implemented on an external server connected to a network. The related document search apparatus can be implemented in a general computer comprising a controller such as a CPU, a storage device such as a ROM or RAM, an external storage device such as an HDD, a display device, and an input device such as a keyboard or a mouse.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A related document search apparatus, comprising:
a first acquisition unit configured to acquire a document and first annotation information added to the document;
a storage configured to store the document, the first annotation information, and correspondence information between the document and the first annotation information;
a search unit configured to search for at least one document related to content of a search document from the storage, to acquire at least one searched document as at least one related document, the search document being a document for a search query;
a second acquisition unit configured to acquire second annotation information which is added to the at least one related document, based on the correspondence information;
a determination unit configured to determine whether or not the second annotation information includes a character; and
a display configured to display the search document and the second annotation information if the second annotation information includes a character, and to display the search document, the second annotation information, and an area of the related document to which the second annotation information is added if the second annotation information includes no character.

2. The apparatus according to claim 1, wherein the storage stores the correspondence information for each page if the search document includes a plurality of pages, and
the display displays a corresponding page of the related document with the second annotation information for each page of the search document.

3. The apparatus according to claim 2, wherein the display displays the second annotation information on an additional page if no page corresponding to a page of the related document is present in the search document.

4. The apparatus according to claim 1, wherein the first acquisition unit sets, as the search document, at least one of an entire of the document and a predefined part of the document.

5. The apparatus according to claim 1, wherein the display displays, if two or more related documents have similar second annotation information, one of the second annotation information as a whole and a difference part between the one of the second annotation information and other second annotation information.

6. The apparatus according to claim 1, wherein the search unit searches for the related document by referring to time and date information of the search document.

7. The apparatus according to claim 1, wherein the second acquisition unit applies a result of character recognition of the second annotation information to the correspondence information.

8. The apparatus according to claim 1, wherein the first annotation information indicates an annotation written by a user.

9. The apparatus according to claim 1, wherein the search document is a document that is currently being created or browsed by a user.

10. The apparatus according to claim 1, wherein the determination unit divides an area to which the second annotation information is added into sub-areas, and performs determination of the sub-areas.

11. A related document search method, comprising:
acquiring a document and first annotation information added to the document;
storing, in a storage, the document, the first annotation information, and correspondence information between the document and the first annotation information;
searching for at least one document related to content of a search document from the storage, to acquire at least one searched document as at least one related document, the search document being a document for a search query;
acquiring second annotation information which is added to the at least one related document, based on the correspondence information;
determining whether or not the second annotation information includes a character; and
displaying the search document and the second annotation information if the second annotation information includes a character, and displaying the search document, the second annotation information, and an area of the related document to which the second annotation information is added if the second annotation information includes no character.

12. The method according to claim 11, wherein the storing the document stores the correspondence information for each page if the search document includes a plurality of pages, and
the displaying displays a corresponding page of the related document with the second annotation information for each page of the search document.

13. The method according to claim 12, wherein the displaying displays the second annotation information on an additional page if no page corresponding to a page of the related document is present in the search document.

14. The method according to claim 11, wherein the acquiring the document sets, as the search document, at least one of an entire of the document and a predefined part of the document.

15. The method according to claim 11, wherein the displaying displays, if two or more related documents have similar second annotation information, one of the second annotation information as a whole and a difference part between the one of the second annotation information and other second annotation information.

16. The method according to claim 11, wherein the searching for the at least one document searches for the related document by referring to time and date information of the search document.

17. The method according to claim 11, wherein the acquiring the second annotation information applies a result of character recognition of the second annotation information to the correspondence information.

18. The method according to claim 11, wherein the first annotation information indicates an annotation written by a user.

19. The method according to claim 11, wherein the search document is a document that is currently being created or browsed by a user.

20. A non-transitory computer readable medium including computer executable instructions, wherein the instructions, when executed by a processor, cause the processor to perform a method comprising:
acquiring a document and first annotation information added to the document;
storing, in a storage, the document, the first annotation information, and correspondence information between the document and the first annotation information;
searching for at least one document related to content of a search document from the storage, to acquire at least one searched document as at least one related document, the search document being a document for a search query;
acquiring second annotation information which is added to the at least one related document, based on the correspondence information;
determining whether or not the second annotation information includes a character; and
displaying the search document and the second annotation information if the second annotation information includes a character, and displaying the search document, the second annotation information, and an area of the related document to which the second annotation information is added if the second annotation information includes no character.
